(19) United States
(12) Patent Application Publication
(10) Pub. No.: US 2010/0011549 A1
(43) Pub. Date: Jan. 21, 2010

(54) COMBINED URN AND MEMORABILIA DISPLAY

(76) Inventor: JOHN E. THOMPSON, SPIRIT LAKE, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/506,875

(22) Filed: Jul. 21, 2009

Related U.S. Application Data
(60) Provisional application No. 61/082,357, filed on Jul. 21, 2008.

(51) Int. Cl. A61G 17/08

(52) U.S. Cl. 27/1

(57) ABSTRACT

An apparatus for multiple storage functions comprising a first portion having walls defining a first cavity for storage, the first portion having an opening into the first cavity which is closeable by a first cover. A second portion defining a second cavity with an opening closeable by a second cover, the second cover having at least a portion of light transmissive material for viewing into the second cavity.

### CROSS-REFERENCE TO RELATED APPLICATIONS

This application claims priority under 35 U.S.C. §119 of a provisional application Ser. No. 61/082,357 filed Jul. 21, 2008, which application is hereby incorporated by reference in its entirety.

### BACKGROUND OF THE INVENTION

1. Field of the Invention

The present invention relates to storage containers and, in particularly, storage containers that have dual purposes, one example being an urn for cremains and a display case for memorabilia. Another example is an urn (a storage container) and display case as a retirement piece (i.e., to store items related to a person's career and display one or more such items or retirement gift(s) or memorabilia). Other uses are possible.

2. Related Art

It is conventional to have a storage device with a single dedicated storage function. This allows the device to be optimized for storing a particular thing.

One example is an urn for cremains. While its ornamental appearance can vary widely, securement of contents and robustness are, most times, primary features for that dedicated function. The urn can be used to store other things (e.g., valuables, retirement memorabilia, etc).

On the other hand, storage devices such as display cabinets tend to emphasize viewability of the memorabilia or item stored in the display case. Glass or other transparent material is usually a prominent feature. This, of course, is much less robust.

Therefore, storage devices such as urns versus memorabilia displays have diverging needs and characteristics.

### BRIEF SUMMARY OF THE INVENTION

The present invention provides a combined urn and display case for memorabilia. The apparatus includes a structurally robust and sealable urn portion with a closeable but externally viewable memorabilia compartment. The combined device allows proper storage of one thing (one example being cremains) with the ability to store another thing (one example being memorabilia such as those associated with a person).

### BRIEF DESCRIPTION OF THE DRAWINGS

FIG. 1A is a perspective view of a first exemplary embodiment (oval shape) according to the invention in assembled form including memorabilia stored and displayed.

FIG. 1B is similar to FIG. 1A but with a top lid opened for access to the memorabilia storage part of the device.

FIG. 1C is similar to FIG. 1B but shows the lid completely removed and without the memorabilia in place.

FIG. 2A is an enlarged perspective view of the base portion of the device.

FIG. 2B is an exploded view of the base portion of the device.

FIG. 3A is an assembled perspective view of the lid of the memorabilia display portion of the device.

FIG. 3B is an exploded view of the lid of FIG. 3A.

FIG. 4A is an assembled perspective view of a second exemplary embodiment (hexagonal shape) according to the invention. It is similar to FIG. 1A.

FIGS. 4B and 4C are similar to FIGS. 1B and 1C except they pertain to the embodiment of FIG. 4A.

FIGS. 5A-B and 6A-B are similar to FIGS. 2A-B and 3A-B, except they relate to the embodiment of FIG. 4A.

### DETAILED DESCRIPTION OF EXEMPLARY EMBODIMENTS

### Overview

For a better understanding of the invention, several exemplary embodiments will now be described in detail. It is to be understood that the context of these specific embodiments will be described in relationship to the above-described drawings. Reference numbers and letters will be used to indicate certain parts and locations throughout the drawings unless otherwise indicated.

On a general level, the exemplary embodiments pertain to a multifunction storage apparatus. The two exemplary embodiments described below specifically function as storage of cremains or retirement memorabilia as a first function and storage and display of one or more things, materials or objects such as memorabilia as a second function. It is to be understood that the specific items stored relative to either function can differ from those examples. The invention is not limited to those specific examples.

### Exemplary Embodiment 1

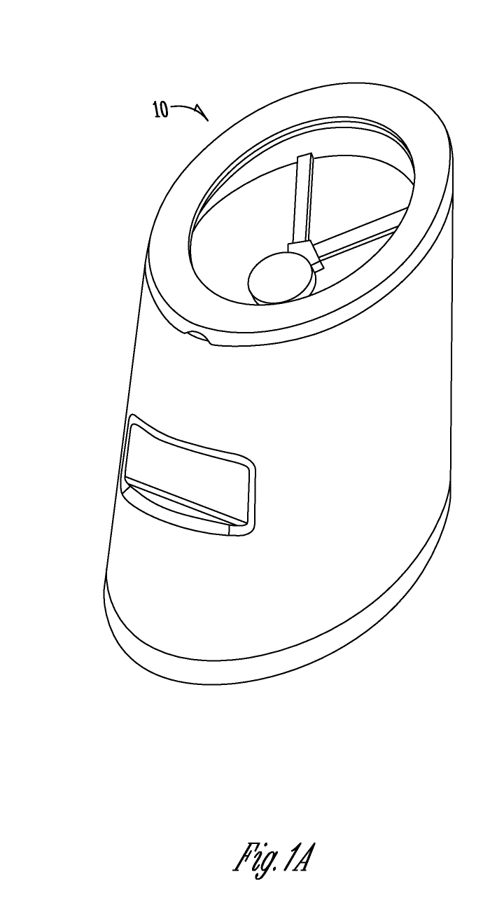

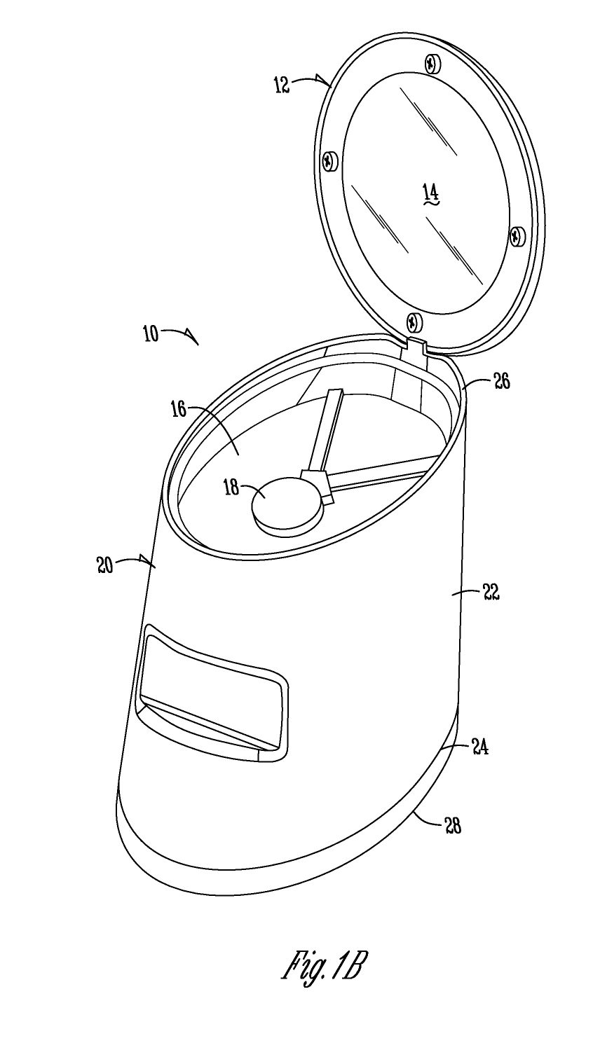

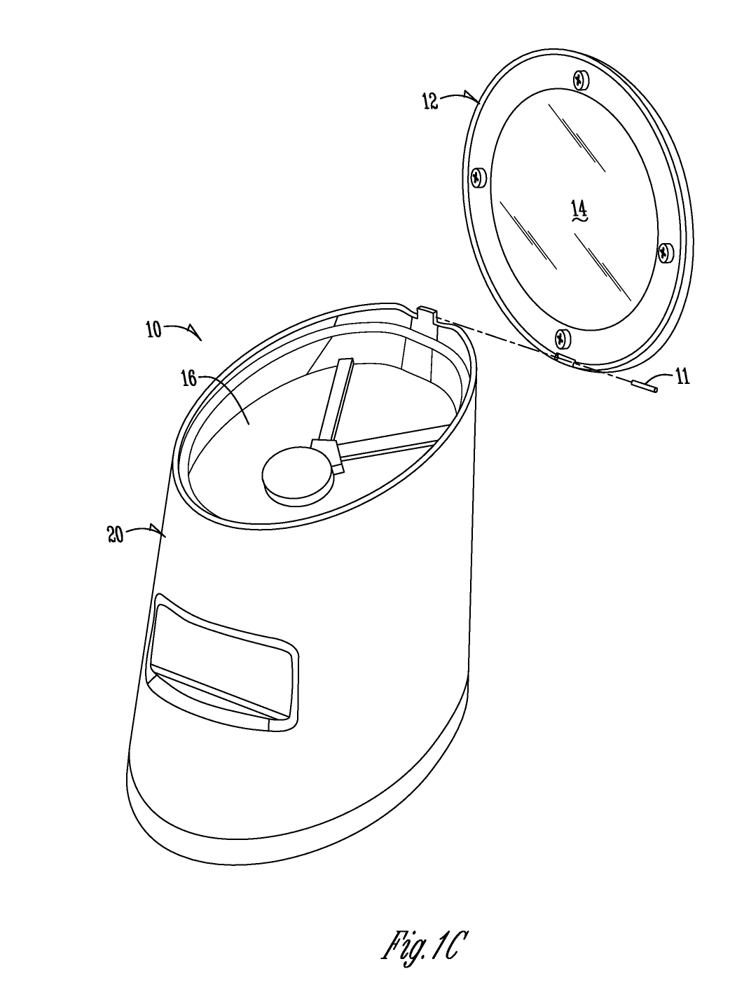

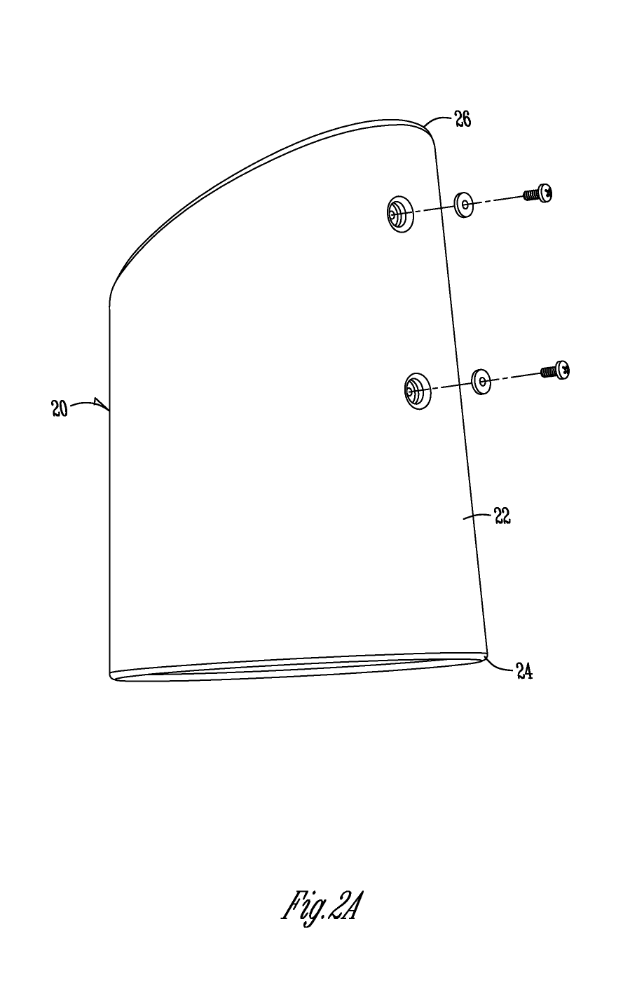

FIGS. 1A-C show a first exemplary embodiment of a multifunction storage apparatus 10. A main base or body 20 functions as an urn to store and contain (e.g. cremains). A cavity 16 in body 20 can be covered by a removable lid 12 (e.g., zinc alloy trimmed with plated precious metal chrome or other precious metals, and/or having a clear cover, e.g. polycarbonate), and function as a second storage space. In this example that storage space is used to display, through a light transmissive lens or window pane 14, memorabilia such as a medal 18. Lid 12 will attach with a pin 11 (FIG. 1C).

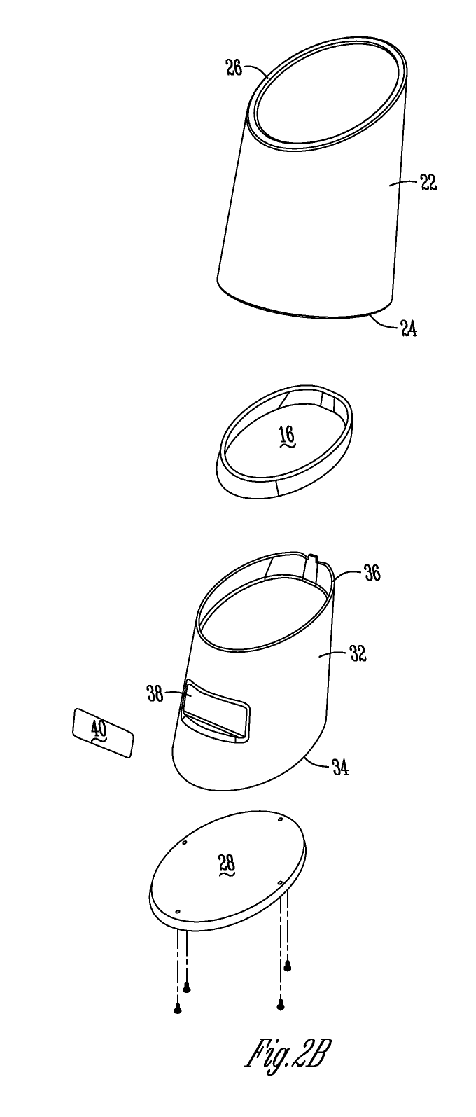

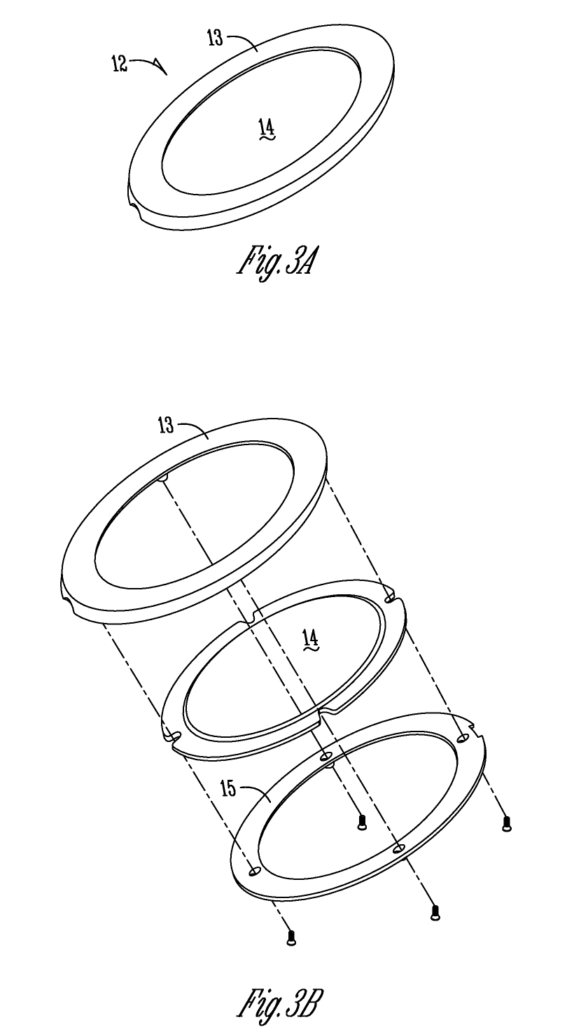

As best indicated at FIGS. 2A and B, main body 20 in this example includes an inverted cup shaped member 32 having a roughly cylindrical shape with a closed off top 36 and an open bottom 34. This inverted cup can be made of any of a variety of materials. An example would be a quite robust and durable material such as metal, ceramic, or plastic. A specific example is die-cast aluminum alloy (e.g., A380 A1). Another is die-cast zinc (e.g. ZA-12). Another example is clear or tinted polycarbonate or acrylic. A robust and durable plate 28 (e.g. metal or other durable material) can be sealingly secured and close off the open bottom to inverted cup 32 by screws or other fasteners. A gasket or other sealing device (not shown) could optionally be used. In this manner a durable storage container for cremains can be created with a removable but at least substantially sealable cover.

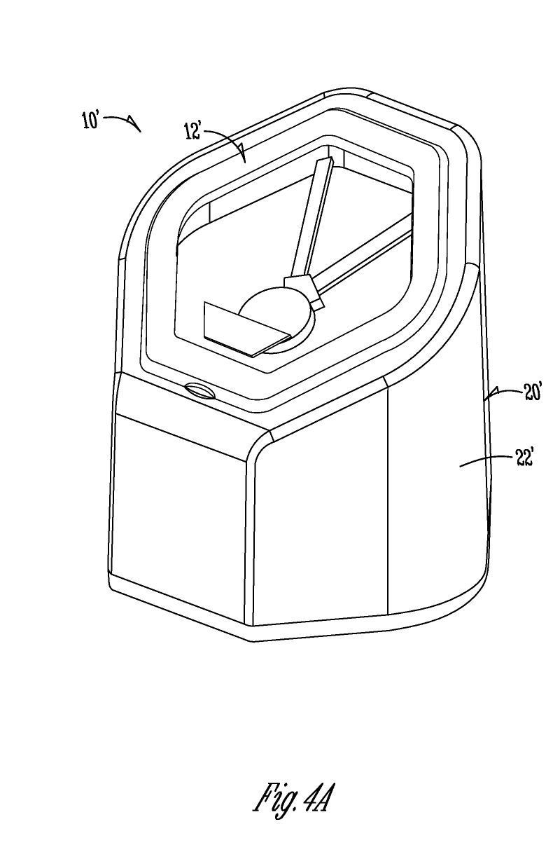

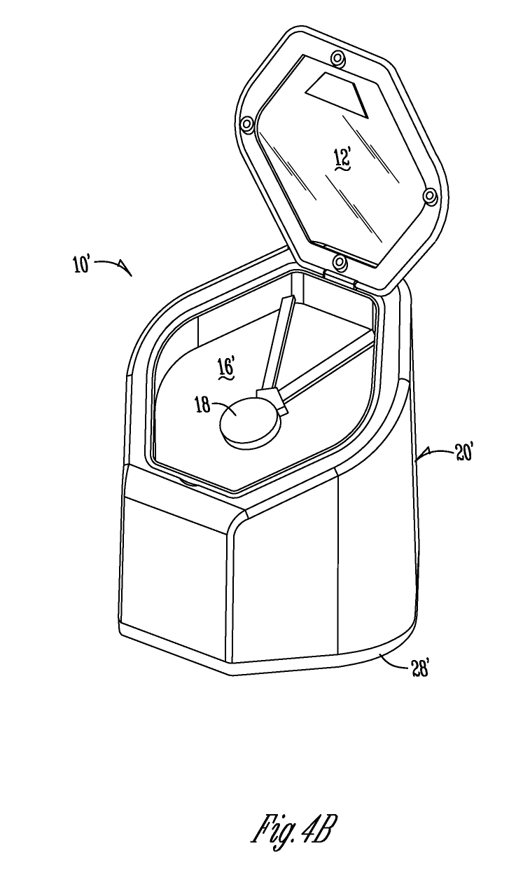

As best shown at FIG. 2B, an additional characteristic of inverted cup 32 is that a cavity 16 is formed in the top of member 32. It can be formed during fabrication such as by die casting, molding, engravement, or other methods appropriate for the material. It is somewhat shallow but of a sufficient volume to contain memorabilia such as, to mention but one example, a medal 18 as shown in FIGS. 1A and B. Optionally, a liner such as metal tray or velour to be fabricated to matingly fit into the cavity in top of member 32 to support and display the memorabilia. One example is velour or other cloth or analogous liner. FIGS. 3A and B show lid 12 can be removably placed over the cavity 16 in the top of member 32 to cover and enclose that cavity. In one example lid 12 can include a light transmissive lens or window pane 14 (e.g., clear or tinted glass or polycarbonate) sandwiched between a frame comprising top metal ring 13 and bottom metal ring 15. The three pieces 13, 14 and 15 can be clamped together by screws, bolts or other fasteners to create the assembly of FIG. 3A. That assembly 12 can matingly fit over (or into) the cavity in the top of member 32. Optionally, there could be a gasket or other sealing device to make it an air tight seal or a substantial seal. There could also be a hinge or a pin 11 to hold cover 12 to body 20. Optionally (not shown) lid 12 could be more robustly mounted such as by screws. Alternatively, some sort of latching mechanism could fix it in place.

Another feature of the first embodiment is best illustrated at FIG. 2B. A glass sleeve 22 (e.g., injection molded polycarbonate—clear or tinted or colored) of complementary shape to inner member 32 could slide over inner member 32 in close conformance and cover a name plate or other member 40 that could fit in or over the receiver 38 in member 32. Plate 40 could be engraved, embossed, or support indicia with identifying information or other graphics. Sleeve 22 could be transparent, translucent, tinted, or have other features that would allow visual discernment of the content of name plate 40 but have an attractive visual affect. Any one or more of a variety of characteristics could be designed into sleeve 22 as well as member 32 to present a desired visual affect. Screws could be used to hold sleeve 22 to member 32 (see FIG. 2A), or other fastening techniques could be used including but not limited to adhesives, clamping, or other methods.

It can be appreciated from the above described figures that device 10 presents a robust urn that is designed to function well to store cremains while concurrently presenting a display chamber for memorabilia presentation that is integrated into the urn. Lid 12 makes display cavity 16 accessible. Bottom removable plate 28 makes the cremains chamber accessible. Plate 28 is removable by screws or other fastening methods. Conventional methods can be used to store cremains in base 20. One example is to place the cremains in a poly bag, seal the bag, and place the bag in base 20 and attach bottom plate 28.

### Exemplary Embodiment 2

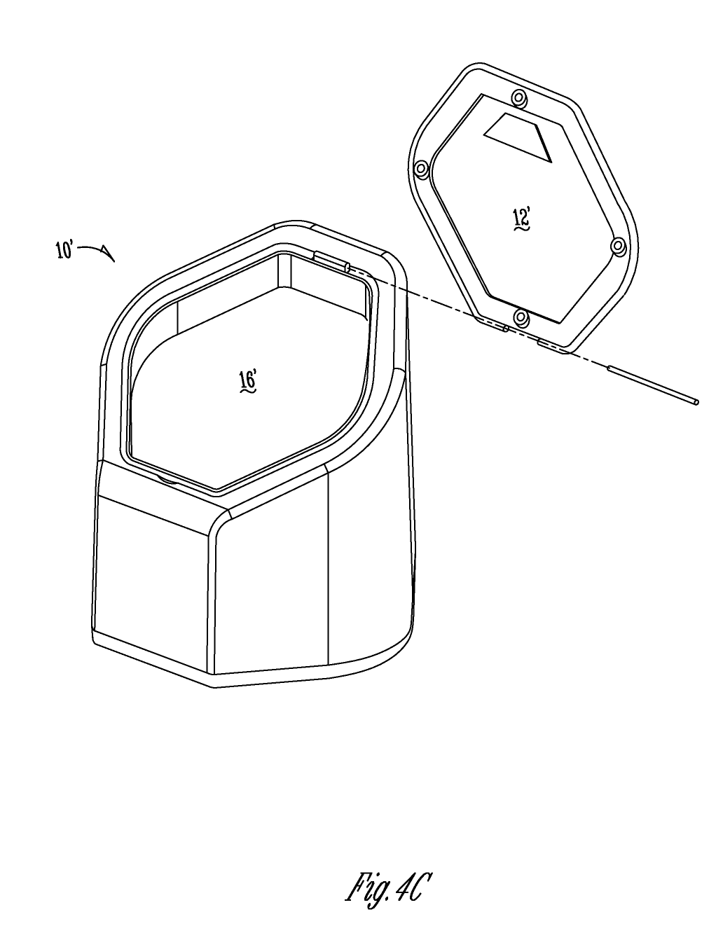

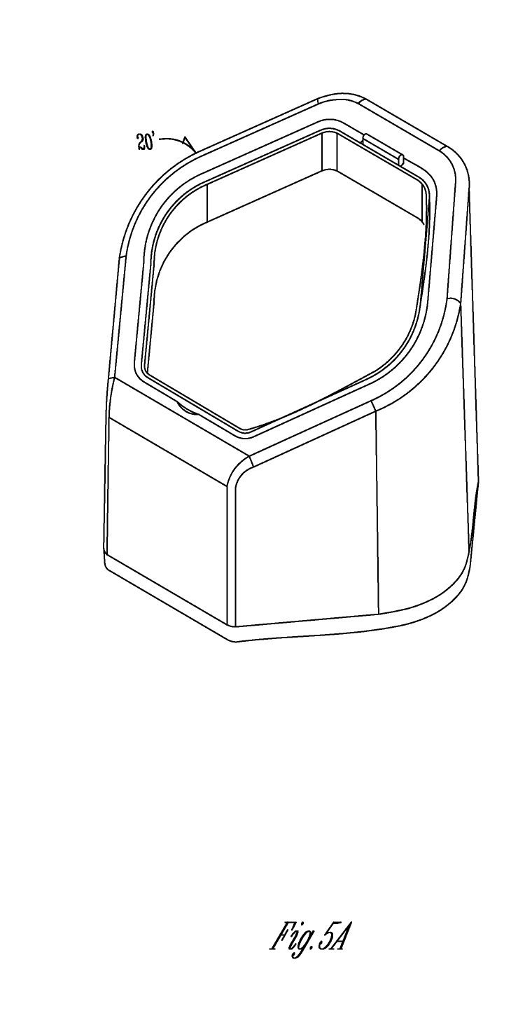

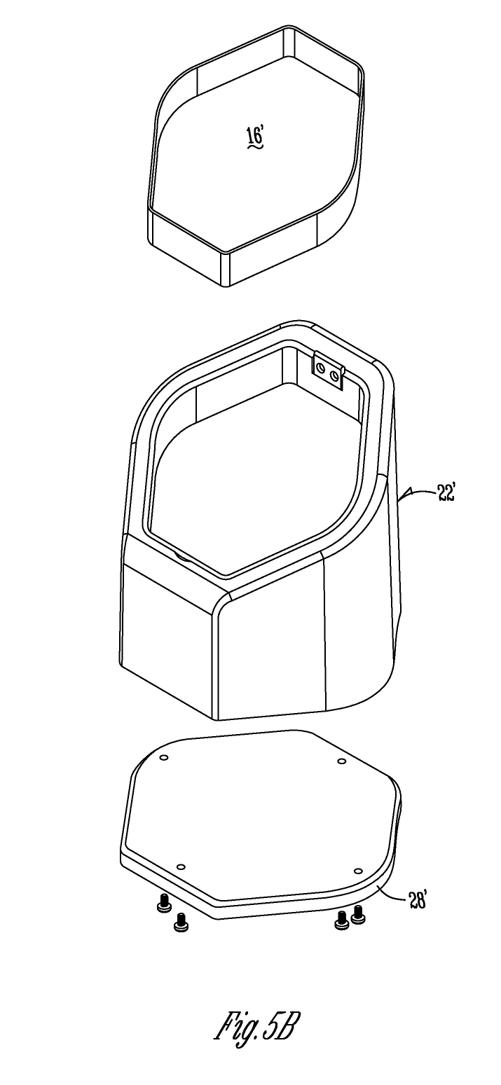

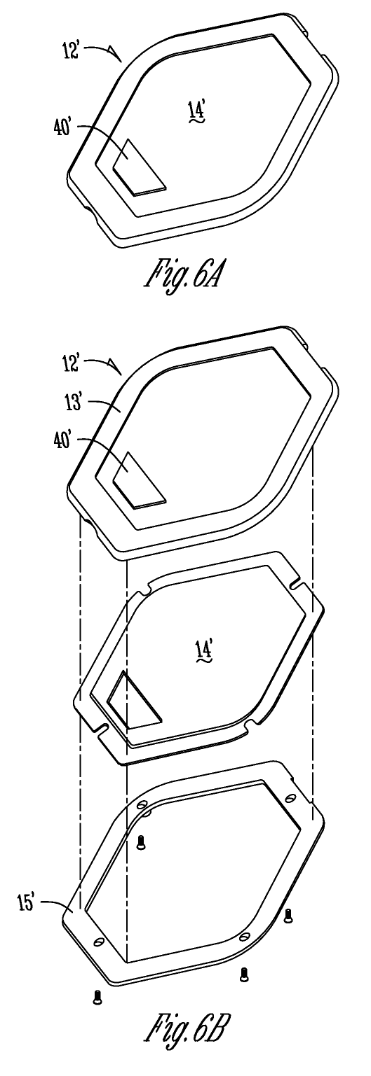

FIG. 4A shows an alternative embodiment of that of FIG. 1A. This device is indicated by reference numeral 10′. By reference to FIGS. 4A-C, 5A-B, and 6A-B, this second embodiment is basically quite similar to the first embodiment described above. Device 10′ has a main urn body 20′ and a lid 12′ that closes off a memorabilia display chamber 16′. The basic concepts are the same for embodiments 1 and 2.

One difference is that name plate 40′ can be mounted on lens 14′ (either on top or on bottom) instead of on the base or body 20. Main body 20′, in this example, can be an inner inverted cup without an outer glass sleeve, although it could have such a sleeve like sleeve 26.

### Options and Alternatives

The two examples described above are meant to illustrate just a couple of forms the invention can take. It is to be appreciated that the invention can take a wide variety of forms and configurations and can be used for a wide variety of storage and presentation functions. Variations obvious to those skilled in the art will be included within the invention.

For example, materials can vary depending on desire or need. The proportions of the storage volume in the inverted cup main body versus the top presentation cavity can vary according to need or desire. In Examples 1 and 2, the storage volume of base 20 or 20′ is a minimum of 210 cubic inches. The volume of upper display storage cavity 16 or 16′ can be seen by reference to the figures, which illustrate different parts in general proportion to one another.

The applications and functions of the device can vary from urn/memorabilia display. One example would be to use the base storage for personal belongings or memorabilia (e.g., valuables, retirement gifts, awards, or time capsule type things) and the top display case for the same or different things.

What is claimed is:

1. An apparatus for multiple storage functions comprising:
a. a first portion having walls defining a first cavity for storage, the first portion having an opening into the cavity which is closeable by a first cover;
b. a second portion defining a second cavity with an opening closeable by a second cover, the second cover having at least a portion of light transmissive material for viewing into the second cavity.

2. The apparatus of claim 1 wherein the second cover comprises trim made from a zinc alloy.

3. The apparatus of claim 2 wherein the trim is plated with chrome or a precious metal.

4. The apparatus of claim 1 wherein the second cavity comprises a liner.

5. The apparatus of claim 4 wherein the liner is velour.

6. The apparatus of claim 1 wherein the light transmissive material comprises a lens or window pane.

7. The apparatus of claim 1 further comprising a display area within the second cavity, the display area having a liner.

8. The apparatus of claim 7 wherein the display area has an inclined surface.

9. The apparatus of claim 8 wherein the second cavity and second cover are coplanar with the inclined surface.

10. The apparatus of claim 1 further comprising cremains of an individual within the first cavity.

11. The apparatus of claim 10 further comprising memorabilia associated with the individual stored in the second cavity

12. The method of claim 11 wherein the memorabilia is selected from the set consisting of a photo, a medal, a retirement gift, and lifetime achievements.

13. A method of storing and visual display of memorabilia comprising:
a. forming a body having a first cavity for storing a first object and a second cavity for storing a second object;
b. closing off the first cavity with a cover and closing off the second cavity with a window to allow viewing into the second cavity.

14. The method of claim 13 further comprising placing cremains of an individual in the first cavity.

15. The method of claim 14 further comprising placing memorabilia associated with the individual in the second cavity such that the memorabilia is visually displayed through the window.

16. The method of claim 15 wherein the memorabilia is selected from the set consisting of a photo, a medal, a retirement gift, and lifetime achievements.

17. The medal of claim 13 further comprising attaching a name plate to the body.

18. An urn for storing cremains comprising:
a. a body having a chamber for storing cremains, said body being in the general shape of an inverted cup with a first and a second cavity, wherein the first cavity has a closable opening for admitting cremains and the second cavity has a lid for admitting memorabilia related to the cremains;
b. the lid comprising a transmissive lens sandwiched between a top ring and a bottom ring;
c. a plate fittingly received on the outside surface for display, wherein the plate may be engraved, embossed or support indicia; and
d. a glass sleeve, wherein said sleeve is of a complementary shape to the body.

19. The apparatus of claim 18 wherein the lid is hingedly attached to the body.

20. The apparatus of claim 18 wherein the lid is fixedly attached by a latching mechanism to the body.
